(19) United States
(12) Patent Application Publication
(10) Pub. No.: US 2011/0061100 A1
(43) Pub. Date: Mar. 10, 2011

(54) METHOD AND APPARATUS FOR CONTROLLING ACCESS

(75) Inventors: JOUKA MIKAEL MATTILA, Tampere (FI); HANNU OLAVI NIEMINEN, Lempaala (FI); MARKUS TAPIO KÄHÄRI, Helsinki (FI); DAVID JOSEPH MURPHY, Helsinki (FI)

(73) Assignee: Nokia Corporation, Espoo (FI)

(21) Appl. No.: 12/557,417

(22) Filed: Sep. 10, 2009

(51) Int. Cl. G06F 21/00; G06F 3/041; G06F 3/01

(52) U.S. Cl. 726/17; 345/173; 715/863

(57) ABSTRACT

An approach is provided for controlling access based at least in part on augmented reality. Images and/or signals representing motion by a user in a physical environment are received. An electronic determination is made whether the motion corresponds to a predetermined motion. Access is granted to a resource based at least in part upon the determination.

### BACKGROUND

Service providers (e.g., wireless and cellular services) and device manufacturers are continually challenged to deliver value and convenience to consumers by, for example, providing compelling network services and advancing the underlying technologies. One area of interest has been in the manner data or service access is controlled. For example, merchants and retailers can restrict wireless (e.g., Wi-Fi) access to paying customers, or presentation materials for a conference are only accessible for attendees of the conference. In other scenarios, it may be required that a person be validated for accessing a service such that the person is verified at the location in question. Alphanumeric username password pairs are commonly used during a log-in process that controls access to protected computer operating systems, mobile phones, cable television (e.g., TV) decoders, automated teller machines (ATMs), etc. However, the typical username password pairs are constrained by its lower level of security (i.e., relatively easy to obtain). In addition, various recourses (e.g., databases, web services, etc.) increase the complexity of password setting requirements (e.g., a combination of 10 numbers and characters without duplications of numbers or characters, excluding names and birth dates information) and frequency of change (e.g., every two weeks). Consequently, such mechanisms have made it cumbersome for users to record and remember the many different pairs of usernames and passwords for different access controlled resources.

### Some Example Embodiments

According to one embodiment, a method comprises receiving a plurality of images and/or signals representing motion by a user in a physical environment. The method further comprises electronically determining whether the motion corresponds to a predetermined motion, and granting access to a resource based at least in part upon the determination.

According to another embodiment, an apparatus comprising at least one processor, and at least one memory including computer program code, the at least one memory and the computer program code configured to, with the at least one processor, cause the apparatus to receive a plurality of images and/or signals representing motion by a user in a physical environment. The apparatus is further caused to electronically determine whether the motion corresponds to a predetermined motion, and grant access to a resource based at least in part upon the determination.

According to another embodiment, a computer-readable storage medium carrying one or more sequences of one or more instructions which, when executed by one or more processors, cause an apparatus to receive a plurality of images and/or signals representing motion by a user in a physical environment. The apparatus is further caused to electronically determine whether the motion corresponds to a predetermined motion, and grant access to a resource based at least in part upon the determination.

According to another embodiment, an apparatus comprises means for receiving a plurality of images and/or signals representing motion by a user in a physical environment. The apparatus further comprises means for electronically determining whether the motion corresponds to a predetermined motion, and granting access to a resource based at least in part upon the determination.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of controlling access based at least in part on augmented reality, according to one embodiment;

FIG. 2 is a diagram of the components of an access control platform, according to one embodiment;

FIG. 3 is a flowchart of a process for controlling access based at least in part on augmented reality, according to one embodiment;

FIG. 4 is a presentation of an image of a physical environment recorded according to one embodiment;

FIG. 5 is a diagram of a user interface utilized in the process of FIG. 3, according to one embodiment;

FIG. 6 is a flowchart of a process for controlling access based at least in part on augmented reality of an interaction between a user and a real life object, according to one embodiment;

FIG. 7 is a diagram of hardware that can be used to implement an embodiment of the invention;

FIG. 8 is a diagram of a chip set that can be used to implement an embodiment of the invention; and

FIG. 9 is a diagram of a mobile station (e.g., handset) that can be used to implement an embodiment of the invention.

### DESCRIPTION OF SOME EMBODIMENTS

A method and apparatus for controlling access based at least in part on augmented reality are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

Although various embodiments are described with respect to access a geographic location or facility, it is contemplated that the approach described herein may be used with other resources, such as data, a database, a software application, a website, an account, a game, a virtual location, a mail box, a deposit box, a locker, a device, a machine, a piece of equipment, etc.

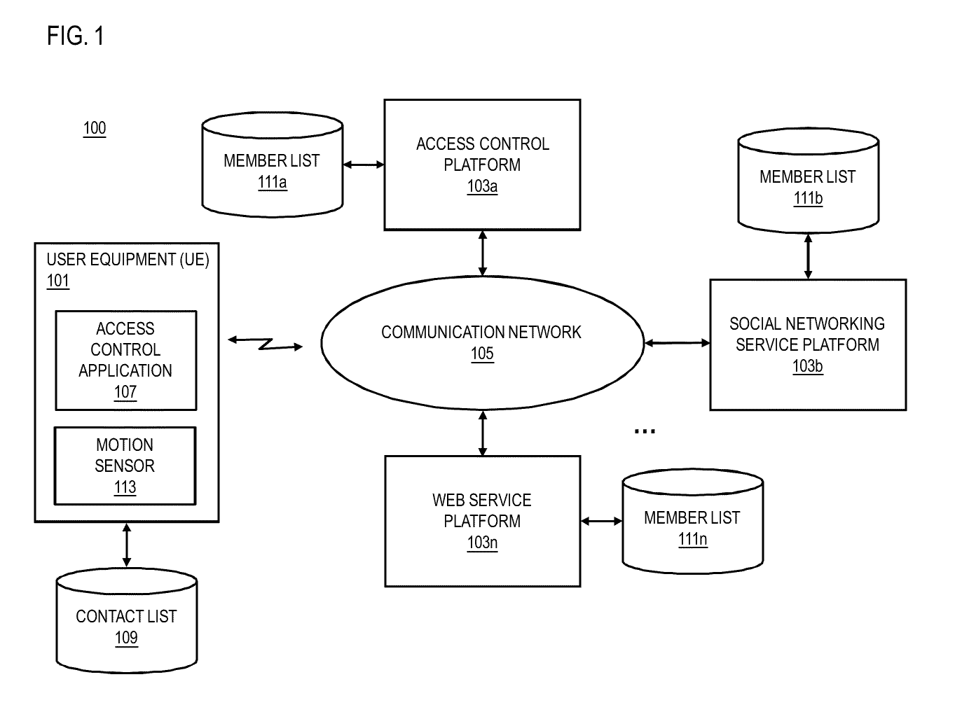

FIG. 1 is a diagram of a system capable of controlling access based at least in part on augmented reality, according to one embodiment. As mentioned, current access control mechanisms involving a user ID and password pair can increase in complexity from the users' perspective as well as the administrator. However, it is recognized that the easier a password is for the owner to remember, the easier it is for a hacker to guess at the correct password. Lists of common passwords are widely available, making password attacks easy to deploy. In addition, passwords are vulnerable to interception (i.e., “snooping,” “key-logging”, etc.) during transmission to an authenticating machine or person. Although single sign-on technology eliminates the need for multiple passwords, this scheme does not relieve users and administrators from the sometimes difficult process of generating and updating effective single passwords.

In view of these issues, a system 100 of FIG. 1 introduces, according to certain embodiments, the capability to control access based at least in part on augmented reality. In one embodiment, the term “augmented reality” refers to using live audio recording, video imagery and/or motion sensing by any number of sensors and recorders, etc. in a physical environment that are digitally processed as motion passwords, and then collecting and comparing data of user motion performed in a similar way to decide whether to grant the user access to a resource.

As shown in FIG. 1, the system 100 comprises a user equipment (UE) 101 having connectivity to, for example, an access control platform 103a, a social networking service platform 103b and a web service platform 103n via a communication network 105. Each of the platforms 103 has a member list database 111, and the UE 101 has a contact list database 109.

In one embodiment, the UE 101 includes at least one motion sensor 113 (e.g., an accelerometer) responsive to motion of a user and providing a signal corresponding to motion of the user. Accordingly, the system 100 uses a user's motion or interaction with a life object in 3 dimensional (3D) space to provide security, data visibility and data access.

By way of example, the communication network 105 of system 100 includes one or more networks such as a data network (not shown), a wireless network (not shown), a telephony network (not shown), or any combination thereof. It is contemplated that the data network may be any local area network (LAN), metropolitan area network (MAN), wide area network (WAN), a public data network (e.g., the Internet), or any other suitable packet-switched network, such as a commercially owned, proprietary packet-switched network, e.g., a proprietary cable or fiber-optic network. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, mobile ad-hoc network (MANET), and the like.

The UE 101 is any type of mobile terminal, fixed terminal, or portable terminal including a mobile handset, station, unit, device, multimedia tablet, Internet node, communicator, desktop computer, laptop computer, Personal Digital Assistants (PDAs), or any combination thereof. It is also contemplated that the UE 101 can support any type of interface to the user (such as “wearable” circuitry, etc.).

In this context, a protocol includes a set of rules defining how the network nodes within the communication network 105 interact with each other based at least in part on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application headers (layer 5, layer 6 and layer 7) as defined by the OSI Reference Model.

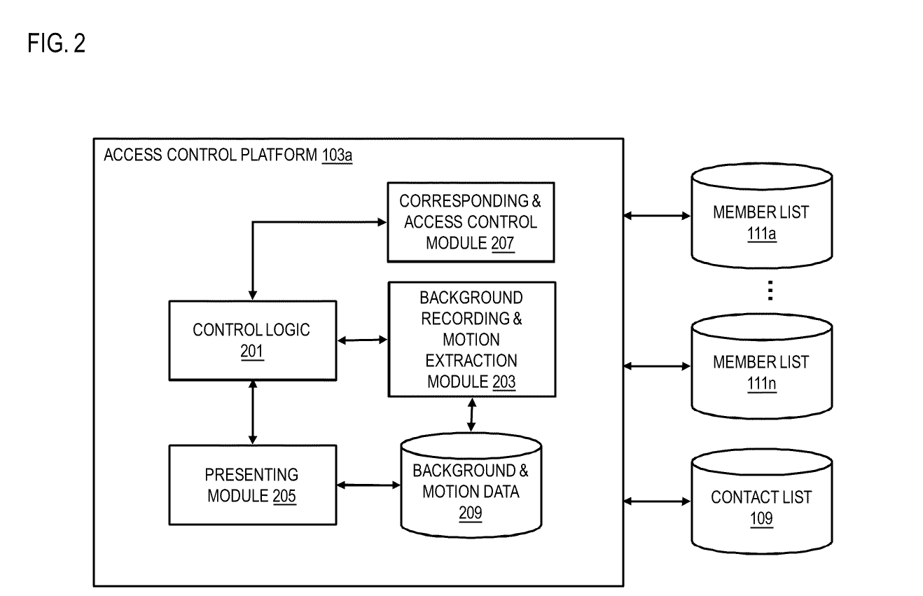

FIG. 2 is a diagram of the components of the access control platform 103a, according to one embodiment. By way of example, the access control platform 103a includes one or more components for providing controlling access based at least in part on augmented reality. It is contemplated that the functions of these components may be combined in one or more components or performed by other components of equivalent functionality. In this embodiment, the access control platform 103a includes at least a control logic 201 which executes at least one algorithm for executing functions of the access control platform 103a, and a background recording and motion extraction module 203 for recording the background (e.g., a physical environment) and extracting a motion of a user according to various embodiments. The access control platform 103a also includes a presenting module 205 for presenting the physical environment to a user that tries to gain access to a resource. A corresponding and access control module 207 determines whether the motion by the user corresponds to a predetermined/pre-recorded motion, thereby granting access to a resource to the user based at least in part upon the determination. The platform 103a further includes a background and motion database 213 for storing backgrounds and motion data.

Alternatively, the functions of the access control platform 103a can be implemented via a access control application (e.g., widget) 107 in the user equipment 101 according to another embodiment. Widgets are light-weight applications, and provide a convenient means for presenting information and accessing services. It is contemplated that the functions of these components may be combined in one or more components or performed by other components of equivalent functionality. In this embodiment, the access control application 107 includes at least a control logic that executes at least one algorithm for executing functions of the access control platform 103a, as previously described. To avoid data transmission costs as well as save time and battery, the control logic can fetch data cached or stored in its own database, without requesting data from any servers or external platforms, such as the access control platform 103a, the social networking service platform 103b and the web service platform 103n. Usually, if the user equipment is online, data queries are made to online search server backends, and once the device is off-line, searches are made to off-line indexes locally.

Augmented reality interaction with the surroundings provides a natural and easy way for authentication, because only minimum effort is needed for an authorized user to gain access, yet significant effort for an unauthorized user to forge or imitate pictures and videos. This kind of “user motion password” is easier to remember than an alphanumeric or device movement password. When using a live camera image, GPS signals, RF signals, motion signals, and combinations thereof, the user is confirmed to be actually at that location rather than trying to access the service from somewhere else. The described embodiments are also applicable to use cases (for example, games using a pattern to grant access to a game level or a game object) that do not requite a high level of authentication.

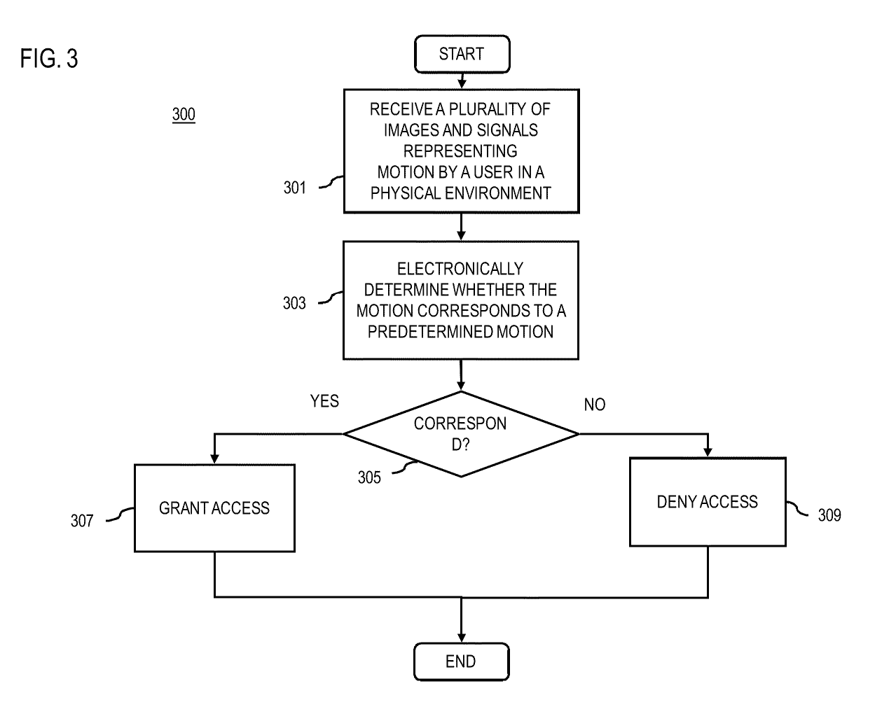

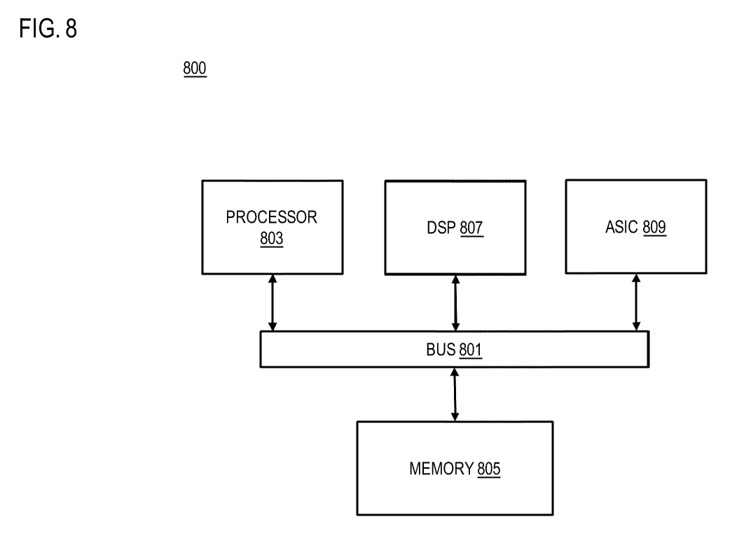

FIG. 3 is a flowchart of a process 300 for controlling access based at least in part on augmented reality, according to one embodiment. In one embodiment, the access control platform 103a performs the process 300 and is implemented in, for instance, a chip set including a processor and a memory as shown FIG. 8. In Step 301, the access control platform 103a receives a plurality of images and/or signals that represent motion (or a sequence of motions) by a user in a physical environment. By way of example, the motion comprises any combination of physical movements or audible actions (e.g., whistling, clapping, etc.). Thereafter, the access control platform 103a electronically determines whether the motion corresponds to a predetermined motion (Step 303). If the determination is that there is a match or correspondence between the user motion and the predetermined motion (Step 305), the access control platform 103a grants the user access to a resource (Step 307). Otherwise, if the determination is of no correspondence, the access control platform 103a denies the user access to a resource (Step 309).

By way of example, the access control platform 103a uses augmented reality via a camera (not shown) of the UE 101 to provide a virtual “key under doormat” effect. A user looks at the local environment through the camera and interacts with the camera in a certain way in order to authenticate to the local service (e.g., WLAN).

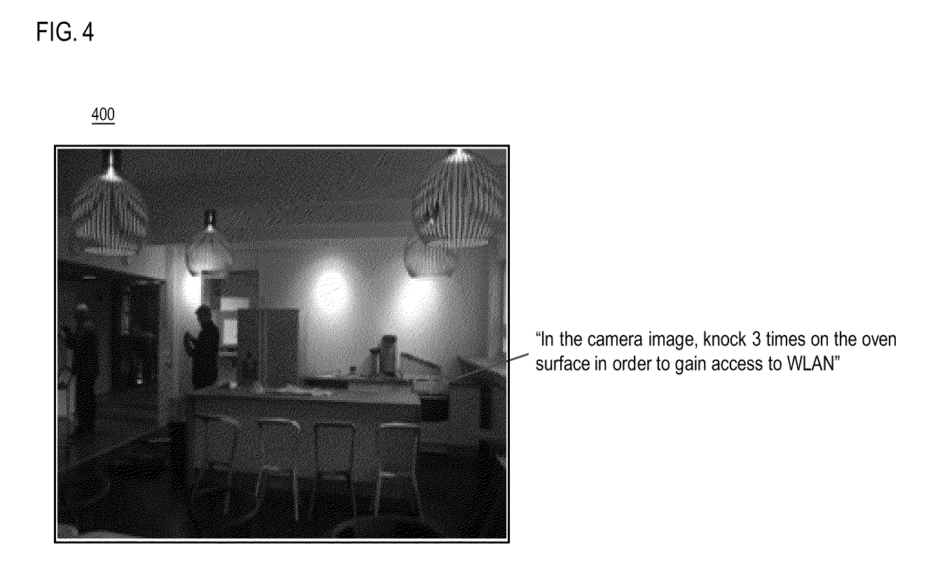

FIG. 4 is a presentation of an image 400 of a physical environment recorded according to one embodiment. In this example, the user actually enters in an office cafeteria and knocks three times on the oven surface. Alternatively, the user only uses a touch screen of the UE 101 to gain access without visiting the office cafeteria. Interaction flow can involve, for example, drawing a line/circle in a pre-designated place, or knocking a predetermined number of times (e.g., three times) on the oven surface of the image 400, etc.

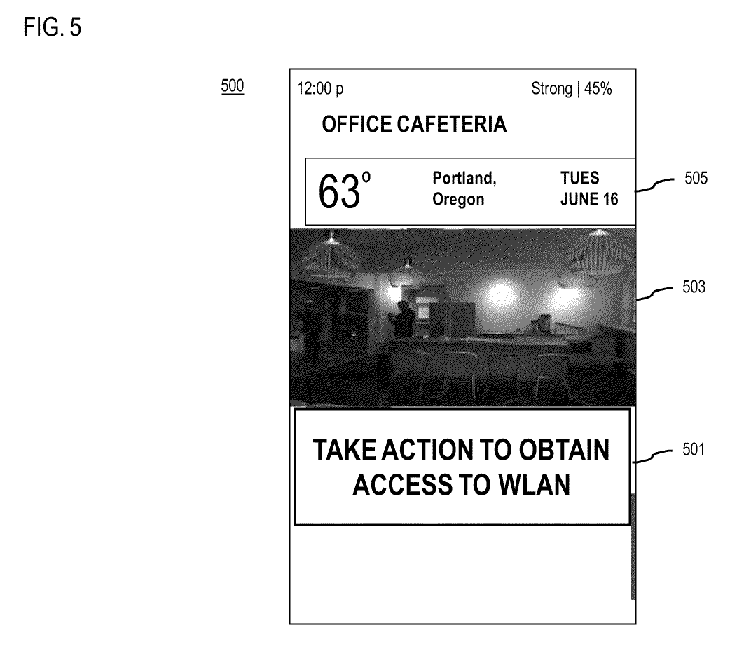

FIG. 5 is a diagram of a user interface utilized in the process 300 of FIG. 3, according to one embodiment. In this example, the user interface includes an area 501 showing an instruction to prompt the user to take an action to obtain access to WLAN in the office cafeteria, an area 503 showing the image of the office cafeteria, and an area 505 showing the local temperature, the city and the date at the place where the UE 101 is located.

In one embodiment, the recording of the environment and the user motion/interaction flow can occur concurrently or in parallel. Alternatively, the recoding can be executed by the user equipment and then forwarded to the access control platform 103a. The mobile application (e.g., the access control application 107) sends the image data (or features pre-calculated from the image data), the interaction flow, and the available metadata to the access control platform 103a. In this embodiment, the interaction flow is recorded as, for instance, <pixel, timestamp> tuples.

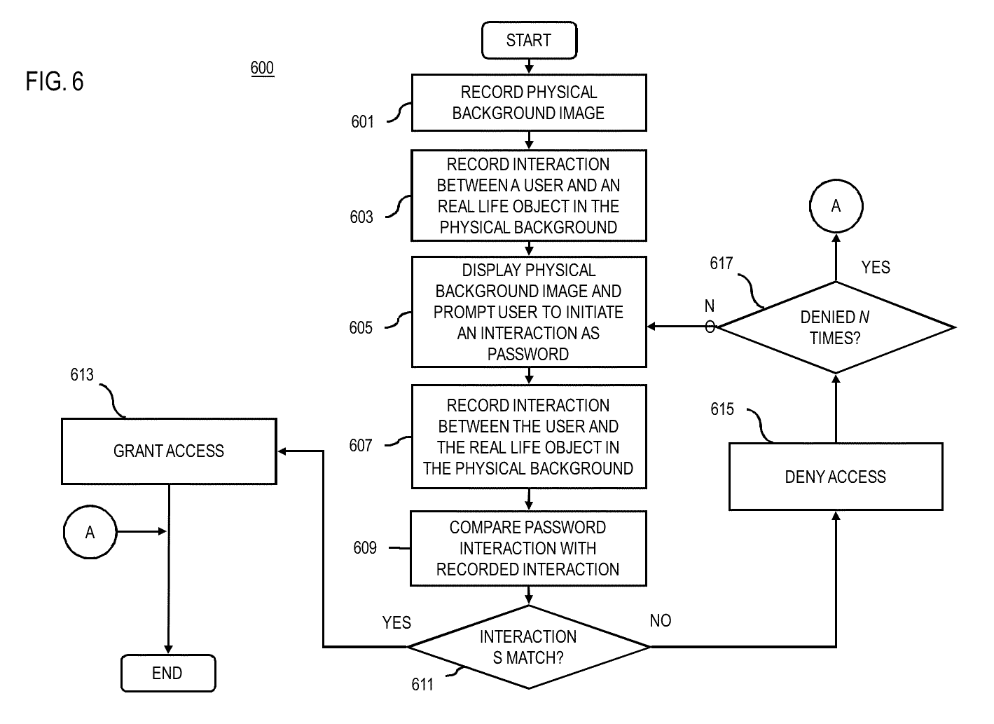

FIG. 6 is a flowchart of a process 600 for controlling access based at least in part on augmented reality of an interaction between a user and a real life object, according to one embodiment. In this example, in Step 601, either the access control platform 103a or the access control application 107 initiates recording an image of a physical environment including a real life object. Referring back to FIG. 4, the access control application 107 of the UE 101 records the environment with a mobile device camera, for example, by taking a panoramic image of the office cafeteria. In FIG. 4, the real life object is an oven. In another embodiment, the real life object is the UE 101, the interaction includes touching a screen of the user equipment by the user, and the images comprise at least one of still images, video, executable application, interactive animation, music, and sound. In another embodiment, the access control application 107 collects motion signals by an accelerometer, a gyroscope, a compass, a GPS device, other motion sensors, or combinations thereof. The motion signals can be used independently or in conjunction with the images to control access.

Available metadata such as location information, compass bearing etc. are stored as metadata in an image exchangeable image file format (Exif). The UE 101 can use GPS, a cell ID and other techniques to measure the user location. In other embodiments, the UE 101 has a compass or various position and orientation measuring sensors that can measure exact direction and angle where the UE 101 is turned. Also, the UE 101 includes various other sensors, e.g., microphones, touch screens, light sensors, etc.

The sensors may include an electronic compass that gives heading information and reflects whether the UE 101 is held horizontally or vertically, a 3-axis accelerometer that gives the orientation of the UE 101 in three axes (pitch, roll and yaw) and determines types of movements (such as running, jumping etc. since these actions cause specific periodic accelerations), or a gyroscope that reads an angular velocity of rotation to capture quick head rotations.

The sensors can be independent devices or incorporated into the UE 100, a head/ear phone, a wrist device, a pointing device, or a head mounted display. By way of example, the user wears a sensor that is in a headphone and provides directional haptics feedback to determine the position of the ears in a space. The user can wear a head mounted display with sensors to determine the position and the orientation of the user's head and view. The user can wear a device around a belt, a wrist or integrated to a headset. The device gives an indication of the direction of an object of interest in a 3D space using haptics stimulation. The haptics stimulation may use simple haptics patterns to carry more information. For example, a frequency of stimulation indicates how close the user is to the object of interest.

Either the access control platform 103a or the access control application 107 then initiates recording images of an interaction between the user and the object (Step 603). Images in augmented reality space are used when a predefined combination of images and user actions or interactions with objects is executed. By way of example, the interaction comprises one or more actions by the user upon the object and is defined by at least one of the following conditions: at a predetermined location, with a predetermined amount of force, for a predetermined length of time, at a predetermined speed, at a predetermined angle, at a predetermined route, at a predetermined time, using a predetermined sound, and following a predetermined action sequence. The sound can be a voice, a click, a musical tune, a noise, any audible or detectable sound waves, or combinations thereof.

One example of these conditions used in the process 600 includes that an exact position of the object in a 3D space (where the distance between the user and the object has to reach a predefined range. As another example, the resource becomes accessible when a predetermined device is 0.5 meters or closer to the resource. As another example, the resource becomes accessible when the orientation of the object in the 3D space (e.g., a virtual video positioned in the street surface) is tilted in such a way that its back surface is horizontally aligned to the street surface. As another example, the resource becomes accessible when speed and a style of approaching the object reaches a predetermined value and from a predetermined direction (e.g., 30 km/h from the north). As another example, the resource becomes accessible when a route taken when approaching the object. As another example, a video game in a virtual space is activated when a user action (e.g., jumping up and down, kicking up with feet to activate an object, punching in the air, etc.) is performed at the place where the object is. These conditions can be assessed by sensor readings.

In FIG. 4, the user performs interaction with one object (i.e., the oven). In other embodiments, the user performs interaction with multiple objects in the physical world for authentication, e.g., “knock on the oven window, then on the fridge, then on the computer.” “Knocking” involves pointing an augmented-reality camera-phone at the objects, and tapping where it appears on the screen in the camera view. In this case, the system 100 considers the interaction with the objects and their relative positions. When moving from object to object, the sensor readings indicate the user is turning in a correct direction, and even indicates turning by a correct amount. In yet another embodiment, when the user is required to sit in a specific place (e.g., in front of a desktop computer) with the UE 101 pointing 125 degrees from North, the system 101 considers absolute position readings. The sensor information can be captured with the UE 101 while recording the “interaction password” for the first time.

As another example, when the authentication involves a symbol to be drawn on a physical place using an augmented reality device (e.g., by drawing a particular polygon on the UE 101 while pointing the UE 101 at a door to electronically open the door), the system 100 considers the position and the orientation of the UE 101 when interacting with the door, as well as the video-stream of the door. When the UE 101 and the door communicate directly, and the door has, for example, proximity sensors to confirm that the user is standing where the user is entering the interaction password. The user has to stand at a place close to the door (i.e., in the middle of the path to the front door) to be captured by the UE 101.

In addition to a condition that the user is in a particular place, other conditions (e.g., a speed, a direction of movement, a type of movement: jumping, running, etc.) can be determined by sensors as well. For example, in an augmented reality game where the user is required to run at 14 km/h to discover some puzzle or clue, the system 100 determines the running speed of the user from accelerometer data collected by an accelerometer or the UE 101. When the user is required to jump in a particular place to break a virtual box, the jumping location is determined by an accelerometer. When the user is required to spin to reveal content, the spinning is measured with a gyroscope. In another embodiment, the content becomes visible only when in an exact GPS reported position and combined readings of an accelerometer, a compass and a gyroscope over time are met.

In these cases, a computer vision is used for object recognition (e.g., “knock on the oven”) and for improving the accuracy of the system 101. There are state of the art computer vision algorithms which include feature descriptor approaches for assigning scale and rotation invariant descriptors to an object (SIFT, SURF etc). In addition, fast “optical flow” algorithms can be deployed to determine which direction the camera image appears to be rotating in order to confirm the sensor reported rotations

When a user requests access to a resource, the access control platform 103a or the access control application 107 initiates displaying an physical background image (e.g., FIG. 5) and prompts the user to initiate an interaction as password by display on the user equipment “Take Action to Obtain Access to WLAN” (Step 605). The access control platform 103a or the access control application 107 initiates recording interaction between the user and the real life object (e.g., the oven surface) in the background (e.g., the office cafeteria) (Step 607). When a user is asked to perform a motion/interaction as a password, the access control platform 103a or the access control application 107 starts the phone's camera to record the motion/interaction, or uses a user interface (e.g., the screen) of the user equipment to record/sense the required motion/interaction flow. Available metadata such as location and compass bearing can be recorded along the image data and motion/interaction flow.

The access control platform 103a or the access control application 107 compares password interaction with recorded interaction (Step 609). In the example of FIG. 4, the access control platform 103a or the access control application 107 compares the image and motion/interaction flow recordings with the pre-recorded image and motion/interaction flow to decide whether to grant the user access to the WLAN. Computer vision based matching and image registration can be done for example using methods described in an article entitled “SURFTrac: Efficient Tracking and Continuous Object Recognition using Local Feature Descriptors” by Duy-Nguyen Ta et al. published in May 2009 (which is incorporated herein by reference in its entirety). With accurate image based registration, to the access control platform 103a or the access control application 107 ensures the motion/interaction flow corresponding to the user motions and the same real life objects. If the password interaction matches with the recorded interaction (Step 609), the access control platform 103a or the access control application 107 grants the user access to the resource (Step 613). If the interactions do not match with each other (Step 609), the access control platform 103a or the access control application 107 denies the user access to the resource (Step 615), but allows the user to try a few more times (Step 617) until the user has been denied N times (e.g., N=3). In addition, image metadata is used for validation and fastening the image processing pipeline.

The processes 300 and 600 present mechanisms for accessing and interacting with the virtual content in the augmented reality space. Location context, device positions and user deeds or actions are linked to user access rights towards specific content of interest. This technology can be used in various augmented reality applications, such as games, geocaching and information services. By way of example, a skateboarding community can share their videos near a huge staircase of a pedestrian bridge beside a motorway. Those community members who know that information can access the videos in front of the staircase's leftmost rail if (1) their mobile devices are turned towards the ground and (2) the community members whistle a tune of a famous pop group's song.

As another example, access to a sunspot monitoring facility is granted for anyone that turns a particular device towards the sun. The location of the device is used to find the position of the user in relation to the sun to gain access to the facility. As another example, a particular radio channel can only be listened to in the user's car while the user turns on the engine and maintains a driving speed under a predetermined limit on a particular route. As another example, a typical problem-solving and adventure game implemented in a predetermined location, such as a theme park or a community park. Tips and hints are given on where the next object can be found by manipulating a particular game device in certain way.

The described processes 300 and 600 also offer easy to remember yet hard to guess ways to control information and data access, which do not require remembering difficult access passwords or handling any lockers to be carried with the user. The processes allow users to remember access passwords easier because they involve actions. Performing acts can assist with memorization of information much more efficiently than memorizing strictly numbers and letters. The processes further allow user groups/communities to define ways to secure data access.

The processes described herein for providing controlling access based at least in part on augmented reality may be advantageously implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

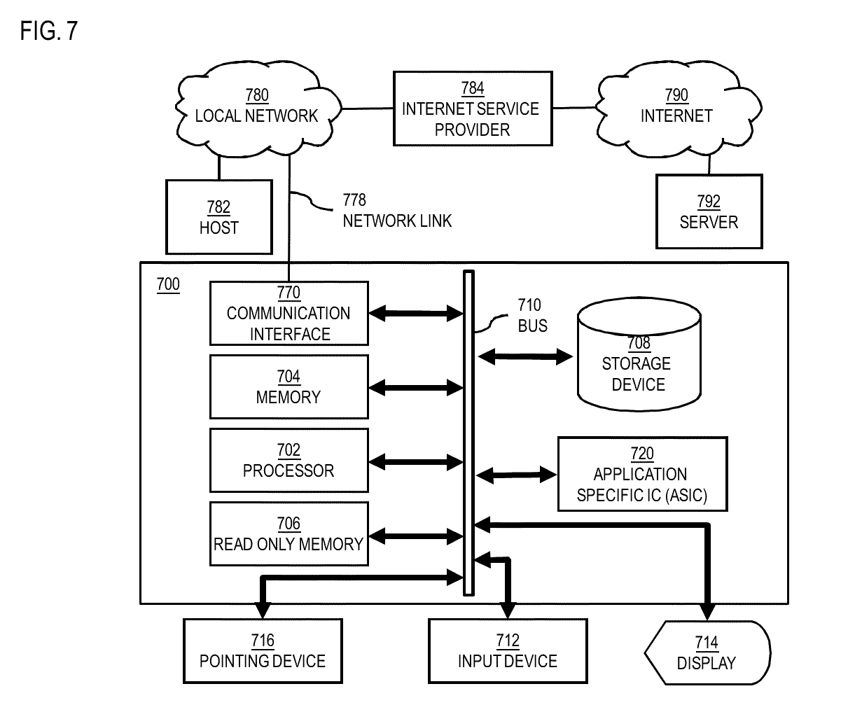

FIG. 7 illustrates a computer system 700 upon which an embodiment of the invention may be implemented. Computer system 700 is programmed (e.g., via computer program code or instructions) to controlling access based at least in part on augmented reality as described herein and includes a communication mechanism such as a bus 710 for passing information between other internal and external components of the computer system 700. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range.

A bus 710 includes one or more parallel conductors of information so that information is transferred quickly among devices coupled to the bus 710. One or more processors 702 for processing information are coupled with the bus 710.

A processor 702 performs a set of operations on information as specified by computer program code related to controlling access based at least in part on augmented reality. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 710 and placing information on the bus 710. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 702, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 700 also includes a memory 704 coupled to bus 710. The memory 704, such as a random access memory (RAM) or other dynamic storage device, stores information including processor instructions for controlling access based at least in part on augmented reality. Dynamic memory allows information stored therein to be changed by the computer system 700. RAM allows a unit of information stored at a location called a memory address to be stored and retrieved independently of information at neighboring addresses. The memory 704 is also used by the processor 702 to store temporary values during execution of processor instructions. The computer system 700 also includes a read only memory (ROM) 706 or other static storage device coupled to the bus 710 for storing static information, including instructions, that is not changed by the computer system 700. Some memory is composed of volatile storage that loses the information stored thereon when power is lost. Also coupled to bus 710 is a non-volatile (persistent) storage device 708, such as a magnetic disk, optical disk or flash card, for storing information, including instructions, that persists even when the computer system 700 is turned off or otherwise loses power.

Information, including instructions for controlling access based at least in part on augmented reality, is provided to the bus 710 for use by the processor from an external input device 712, such as a keyboard containing alphanumeric keys operated by a human user, or a sensor. A sensor detects conditions in its vicinity and transforms those detections into physical expression compatible with the measurable phenomenon used to represent information in computer system 700. Other external devices coupled to bus 710, used primarily for interacting with humans, include a display device 714, such as a cathode ray tube (CRT) or a liquid crystal display (LCD), or plasma screen or printer for presenting text or images, and a pointing device 716, such as a mouse or a trackball or cursor direction keys, or motion sensor, for controlling a position of a small cursor image presented on the display 714 and issuing commands associated with graphical elements presented on the display 714. In some embodiments, for example, in embodiments in which the computer system 700 performs all functions automatically without human input, one or more of external input device 712, display device 714 and pointing device 716 is omitted.

In the illustrated embodiment, special purpose hardware, such as an application specific integrated circuit (ASIC) 720, is coupled to bus 710. The special purpose hardware is configured to perform operations not performed by processor 702 quickly enough for special purposes. Examples of application specific ICs include graphics accelerator cards for generating images for display 714, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 700 also includes one or more instances of a communications interface 770 coupled to bus 710. Communication interface 770 provides a one-way or two-way communication coupling to a variety of external devices that operate with their own processors, such as printers, scanners and external disks. In general the coupling is with a network link 778 that is connected to a local network 780 to which a variety of external devices with their own processors are connected. For example, communication interface 770 may be a parallel port or a serial port or a universal serial bus (USB) port on a personal computer. In some embodiments, communications interface 770 is an integrated services digital network (ISDN) card or a digital subscriber line (DSL) card or a telephone modem that provides an information communication connection to a corresponding type of telephone line. In some embodiments, a communication interface 770 is a cable modem that converts signals on bus 710 into signals for a communication connection over a coaxial cable or into optical signals for a communication connection over a fiber optic cable. As another example, communications interface 770 may be a local area network (LAN) card to provide a data communication connection to a compatible LAN, such as Ethernet. Wireless links may also be implemented. For wireless links, the communications interface 770 sends or receives or both sends and receives electrical, acoustic or electromagnetic signals, including infrared and optical signals, that carry information streams, such as digital data. For example, in wireless handheld devices, such as mobile telephones like cell phones, the communications interface 770 includes a radio band electromagnetic transmitter and receiver called a radio transceiver. In certain embodiments, the communications interface 770 enables connection to the communication network 105 for controlling access based at least in part on augmented reality to the UE 101.

The term computer-readable medium is used herein to refer to any medium that participates in providing information to processor 702, including instructions for execution. Such a medium may take many forms, including, but not limited to, non-volatile media, volatile media and transmission media. Non-volatile media include, for example, optical or magnetic disks, such as storage device 708. Volatile media include, for example, dynamic memory 704. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read. The term computer-readable storage medium is used herein to refer to any computer-readable medium except transmission media.

FIG. 8 illustrates a chip set 800 upon which an embodiment of the invention may be implemented. Chip set 800 is programmed to controlling access based at least in part on augmented reality as described herein and includes, for instance, the processor and memory components described with respect to FIG. 7 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip.

In one embodiment, the chip set 800 includes a communication mechanism such as a bus 801 for passing information among the components of the chip set 800. A processor 803 has connectivity to the bus 801 to execute instructions and process information stored in, for example, a memory 805. The processor 803 may include one or more processing cores with each core configured to perform independently. A multi-core processor enables multiprocessing within a single physical package. Examples of a multi-core processor include two, four, eight, or greater numbers of processing cores. Alternatively or in addition, the processor 803 may include one or more microprocessors configured in tandem via the bus 801 to enable independent execution of instructions, pipelining, and multithreading. The processor 803 may also be accompanied with one or more specialized components to perform certain processing functions and tasks such as one or more digital signal processors (DSP) 807, or one or more application-specific integrated circuits (ASIC) 809. A DSP 807 typically is configured to process real-world signals (e.g., sound) in real time independently of the processor 803. Similarly, an ASIC 809 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 803 and accompanying components have connectivity to the memory 805 via the bus 801. The memory 805 includes both dynamic memory (e.g., RAM, magnetic disk, writable optical disk, etc.) and static memory (e.g., ROM, CD-ROM, etc.) for storing executable instructions that when executed perform the inventive steps described herein to controlling access based at least in part on augmented reality. The memory 805 also stores the data associated with or generated by the execution of the inventive steps.

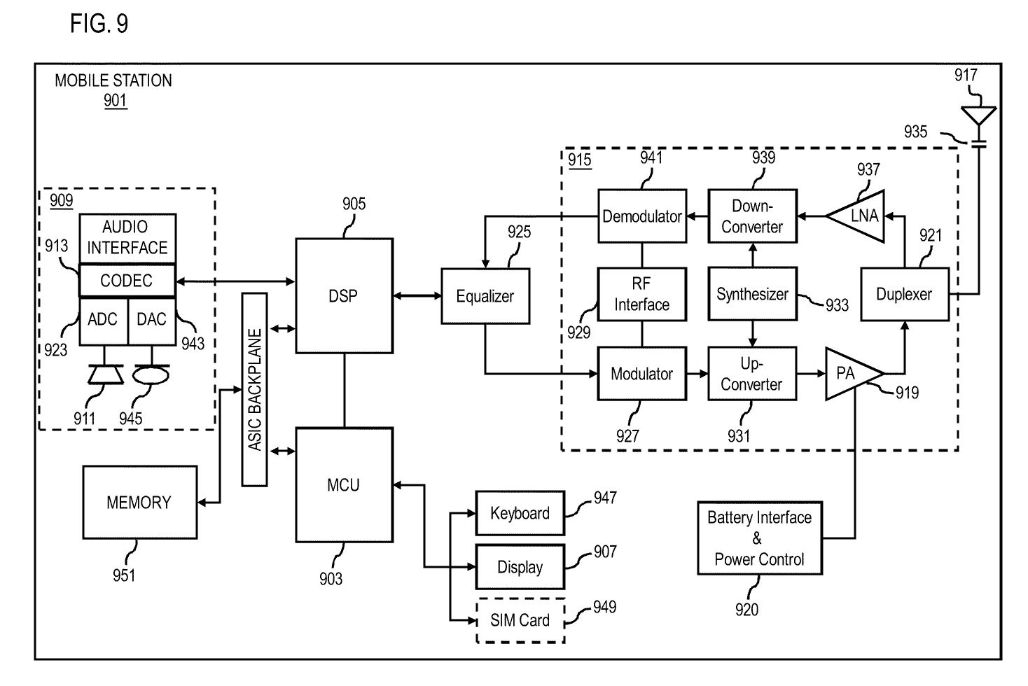

FIG. 9 is a diagram of exemplary components of a mobile station (e.g., handset) capable of operating in the system of FIG. 1, according to one embodiment. Generally, a radio receiver is often defined in terms of front-end and back-end characteristics. The front-end of the receiver encompasses all of the Radio Frequency (RF) circuitry whereas the back-end encompasses all of the base-band processing circuitry. Pertinent internal components of the telephone include a Main Control Unit (MCU) 903, a Digital Signal Processor (DSP) 905, and a receiver/transmitter unit including a microphone gain control unit and a speaker gain control unit. A main display unit 907 provides a display to the user in support of various applications and mobile station functions that offer automatic contact matching. An audio function circuitry 909 includes a microphone 911 and microphone amplifier that amplifies the speech signal output from the microphone 911. The amplified speech signal output from the microphone 911 is fed to a coder/decoder (CODEC) 913.

A radio section 915 amplifies power and converts frequency in order to communicate with a base station, which is included in a mobile communication system, via antenna 917. The power amplifier (PA) 919 and the transmitter/modulation circuitry are operationally responsive to the MCU 903, with an output from the PA 919 coupled to the duplexer 921 or circulator or antenna switch, as known in the art. The PA 919 also couples to a battery interface and power control unit 920.

In use, a user of mobile station 901 speaks into the microphone 911 and his or her voice along with any detected background noise is converted into an analog voltage. The analog voltage is then converted into a digital signal through the Analog to Digital Converter (ADC) 923. The control unit 903 routes the digital signal into the DSP 905 for processing therein, such as speech encoding, channel encoding, encrypting, and interleaving. In one embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like.

The encoded signals are then routed to an equalizer 925 for compensation of any frequency-dependent impairments that occur during transmission though the air such as phase and amplitude distortion. After equalizing the bit stream, the modulator 927 combines the signal with a RF signal generated in the RF interface 929. The modulator 927 generates a sine wave by way of frequency or phase modulation. In order to prepare the signal for transmission, an up-converter 931 combines the sine wave output from the modulator 927 with another sine wave generated by a synthesizer 933 to achieve the desired frequency of transmission. The signal is then sent through a PA 919 to increase the signal to an appropriate power level. In practical systems, the PA 919 acts as a variable gain amplifier whose gain is controlled by the DSP 905 from information received from a network base station. The signal is then filtered within the duplexer 921 and optionally sent to an antenna coupler 935 to match impedances to provide maximum power transfer. Finally, the signal is transmitted via antenna 917 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile station 901 are received via antenna 917 and immediately amplified by a low noise amplifier (LNA) 937. A down-converter 939 lowers the carrier frequency while the demodulator 941 strips away the RF leaving only a digital bit stream. The signal then goes through the equalizer 925 and is processed by the DSP 905. A Digital to Analog Converter (DAC) 943 converts the signal and the resulting output is transmitted to the user through the speaker 945, all under control of a Main Control Unit (MCU) 903—which can be implemented as a Central Processing Unit (CPU) (not shown).

The MCU 903 receives various signals including input signals from the keyboard 947. The keyboard 947 and/or the MCU 903 in combination with other user input components (e.g., the microphone 911) comprise a user interface circuitry for managing user input. The MCU 903 runs a user interface software to facilitate user control of at least some functions of the mobile station 901 to controlling access based at least in part on augmented reality. The MCU 903 also delivers a display command and a switch command to the display 907 and to the speech output switching controller, respectively. Further, the MCU 903 exchanges information with the DSP 905 and can access an optionally incorporated SIM card 949 and a memory 951. In addition, the MCU 903 executes various control functions required of the station. The DSP 905 may, depending upon the implementation, perform any of a variety of conventional digital processing functions on the voice signals. Additionally, DSP 905 determines the background noise level of the local environment from the signals detected by microphone 911 and sets the gain of microphone 911 to a level selected to compensate for the natural tendency of the user of the mobile station 901.

The CODEC 913 includes the ADC 923 and DAC 943. The memory 951 stores various data including call incoming tone data and is capable of storing other data including music data received via, e.g., the global Internet. The software module could reside in RAM memory, flash memory, registers, or any other form of writable storage medium known in the art. The memory device 951 may be, but not limited to, a single memory, CD, DVD, ROM, RAM, EEPROM, optical storage, or any other non-volatile storage medium capable of storing digital data.

An optionally incorporated SIM card 949 carries, for instance, important information, such as the cellular phone number, the carrier supplying service, subscription details, and security information. The SIM card 949 serves primarily to identify the mobile station 901 on a radio network. The card 949 also contains a memory for storing a personal telephone number registry, text messages, and user specific mobile station settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method comprising:
receiving at least one of images and signals representing motion by a user in a physical environment;
electronically determining whether the motion corresponds to a predetermined motion; and
granting access to a resource based at least in part upon the determination.

2. A method of claim 1, wherein the resource is data, a database, a software application, a website, an account, a game, a virtual location, a mail box, a deposit box, a locker, a geographic location, a device, a machine, a piece of equipment, or a combination thereof.

3. A method of claim 1, wherein the motion comprises an interaction between a user and a real life object in the physical environment, and
the interaction is performed under at least one of conditions: at a predetermined location, with a predetermined amount of force, for a predetermined length of time, at a predetermined speed, at a predetermined angle, at a predetermined route, at a predetermined time, using a predetermined sound, and following a predetermined action sequence.

4. A method of claim 3, wherein the object is a user equipment, and the interaction includes touching a screen of the user equipment by the user.

5. A method of claim 1, further comprising:
displaying an image of the physical environment; and
prompting a user to initiate the motion to gain access to the resource.

6. A method of claim 3, further comprising:
determining whether the at least one of the conditions are satisfied by detecting a location, an amount of force, a length of time, a speed, an angle, a route, and a sound of the interaction.

7. A method of claim 1, further comprising:
electronically determining whether the physical environment corresponds to a predetermined physical environment; and
granting access to the resource based at least in part on the determination of the correspondence of physical environments.

8. An apparatus comprising:
at least one processor; and
at least one memory including computer program code,
the at least one memory and the computer program code configured to, with the at least one processor, cause the apparatus to perform at least the following,
receive at least one of images and signals representing motion by a user in a physical environment;
electronically determine whether the motion corresponds to a predetermined motion; and
grant access to a resource based at least in part upon the determination.

9. An apparatus of claim 8, wherein the resource is data, a database, a software application, a website, an account, a game, a virtual location, a mail box, a deposit box, a locker, a geographic location, a device, a machine, a piece of equipment, or a combination thereof.

10. An apparatus of claim 8, wherein the motion comprises an interaction between a user and a real life object in the physical environment, and
the interaction is performed under at least one of the conditions: at a predetermined location, with a predetermined amount of force, for a predetermined length of time, at a predetermined speed, at a predetermined angle, at a predetermined route, at a predetermined time, using a predetermined sound, and following a predetermined action sequence.

11. An apparatus of claim 10, wherein the object is a user equipment, and the interaction includes touching a screen of the user equipment by the user.

12. An apparatus of claim 8, wherein the apparatus is further caused to:
display an image of the physical environment; and
prompt a user to initiate the motion to gain access to the resource.

13. An apparatus of claim 10, wherein the apparatus is further caused to:
determine whether the at least one of the conditions are satisfied by detecting a location, an amount of force, a length of time, a speed, an angle, a route, and a sound of the interaction.

14. An apparatus of claim 8, wherein the apparatus is further caused to:
electronically determine whether the physical environment corresponds to a predetermined physical environment; and
grant access to the resource based at least in part on the determination of the correspondence of physical environments.

15. A computer-readable storage medium carrying one or more sequences of one or more instructions which, when executed by one or more processors, cause an apparatus to perform at least the following:
receiving at least one of images and signals representing motion by a user in a physical environment;
electronically determining whether the motion corresponds to a predetermined motion; and
granting access to a resource based at least in part upon the determination.

16. A computer-readable storage medium of claim 15, wherein the resource is data, a database, a software application, a website, an account, a game, a virtual location, a mail box, a deposit box, a locker, a geographic location, a device, a machine, a piece of equipment, or a combination thereof.

17. A computer-readable storage medium of claim 16, wherein the motion comprises an interaction between a user and a real life object in the physical environment, and the interaction is performed under at least one of the conditions: at a predetermined location, with a predetermined amount of force, for a predetermined length of time, at a predetermined speed, at a predetermined angle, at a predetermined route, at a predetermined time, using a predetermined sound, and following a predetermined action sequence.

18. A computer-readable storage medium of claim 17, wherein the object is a user equipment, and the interaction includes touching a screen of the user equipment by the user.

19. A computer-readable storage medium of claim 15, wherein the apparatus is caused to further perform:
displaying an image of the physical environment; and
prompting a user to initiate the motion to gain access to the resource.

20. A computer-readable storage medium of claim 17, wherein the apparatus is caused to further perform:
determining whether the at least one of the conditions are satisfied by detecting a location, an amount of force, a length of time, a speed, an angle, a route, and a sound of the interaction.
